(19) United States
(12) Patent Application Publication
(10) Pub. No.: US 2012/0233198 A1
(43) Pub. Date: Sep. 13, 2012

(54) CREATING VIRTUAL WORLDS FROM EXISTING DATA STRUCTURES

(75) Inventors: JARON LANIER, SAUSALITO, CA (US); EYAL OFEK, REDMOND, WA (US); JOHN CLAVIN, SEATTLE, WA (US)

(73) Assignee: MICROSOFT CORPORATION, REDMOND, WA (US)

(21) Appl. No.: 13/045,271

(22) Filed: Mar. 10, 2011

(51) Int. Cl. G06F 17/30

(52) U.S. Cl. 707/769; 707/803; 707/E17.005; 707/E17.014

(57) ABSTRACT

Virtual worlds are generated from pre-existing data structures containing non-geometric data. An existing data structure containing non-geometric data is access and queried to identify parameters and the dependency structure of data in the data structure. Geometric objects are designed based on the identified parameters and dependency structure, and a virtual world is created from the geometric objects.

### BACKGROUND

With the continued growth of computer usage, networking, and data storage capacities, there is a tremendous amount of stored electronic data. Existing data structures (e.g., FACEBOOK data, TWITTER data, the USPTO patent database, search engine search results, a user's email inbox, contents from a word processing document, etc.) store large amounts of data for a variety of different purposes. Generally, a variety of computer applications may be used to present information from these data structures to users. However, the way this information is presented to users may not be particularly intuitive, especially if the data is somewhat abstract to users. As a result, it may be difficult for users to understand and navigate the data.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to automatically generating virtual worlds from existing data structures. The existing data structures may include non-geometric data that was intended for purposes other than creating virtual worlds. When generating a virtual world, an existing data structure is queried to identify parameters and the dependency structure of the data. The identified parameters and dependency structure may be employed to generate geometric objects, which are in turn used to generate a virtual world. In some embodiments, the process may be bidirectional such that changes made to the virtual world may be converted back to non-geometric data and stored in the existing data structure from which the virtual world was created. While in some embodiments a virtual world may be generated entirely from an existing data structure containing non-geometric data, in other embodiments a virtual world may be generated by employing both an existing data structure containing non-geometric data and another existing data structure containing geometric data.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a flow diagram showing a method for generating a virtual world using a pre-existing data structure containing non-geometric data in accordance with an embodiment of the present invention;

FIG. 3 is a flow diagram showing a method for making changes to an underlying data structure based on changes made to a virtual world to in accordance with an embodiment of the present invention; and

FIG. 4 is a flow diagram showing a method for employing both non-geometric data and geometric data to generate a virtual world in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are generally directed to creating virtual worlds from existing data structures. The existing data structures may include non-geometric data that was originally intended for other purposes. This may include any of a variety of different content, such as FACEBOOK data, TWITTER data, the USPTO patent database, search engine search results, a user's email inbox, or contents from a word processing document, to provide a few examples.

The process of converting non-geometric data from an existing data structure may include querying the data structure to identify parameters and to understand the dependency structure of the data. Transformations may be applied to the identified parameters and dependency structure to design virtual geometric objects, which are in turn used to generate a virtual world.

In some embodiments, the process may be bilateral. In particular, in addition to creating a virtual world from an existing data structure, embodiments may allow for changes made to the virtual world to result in changes to the existing data structure. When a change is made to a virtual world created from an existing data structure in accordance with embodiments of the present invention, reverse transformations may be applied to those virtual world changes to generate non-geometric data that is then stored in the existing data structure as new data or replacing/modifying existing data in the data structure.

While some embodiments generate virtual worlds entirely from non-geometric data, other embodiments may also employ geometric data in addition to non-geometric data to generate virtual worlds. In such embodiments, both a first data structure containing non-geometric data and a second data structure containing geometric data are queried to identify parameters and the dependency structure of the data. The combined parameters and dependency structures may then be used to design geometric objects, and a virtual world may be generated from those geometric objects.

In accordance with various embodiments of the present invention, “virtual worlds” may be created using any technology along the virtuality continuum. As such, virtual worlds may be created that are entirely virtual. Additionally, virtual worlds may be created using augmented-reality techniques. For instance, an augmented-reality virtual would could be created from FACEBOOK data that provides an informative-but-surreal virtual miniature golf course superimposed on a person's physical front lawn (e.g., using a heads-up display while looking at the front lawn). The virtual miniature golf course may include, for instance, a stork if the person just had a new grandchild.

Accordingly, in one aspect, an embodiment of the present invention is directed to one or more computer storage media storing computer-useable instructions, that when used by one or more computing devices, cause the one or more computing devices to perform a method. The method includes accessing an existing data structure containing non-geometric data that was originally generated for a purpose other than creating a virtual world representation. The method also includes querying the existing data structure to identify parameters for use in generating a virtual world. The method further includes designing geometric objects based on the parameters identified from the existing data structure. The method still further includes generating the virtual world using the geometric objects.

In another embodiment, an aspect of the invention is directed to one or more computer storage media storing computer-useable instructions, that when used by one or more computing devices, cause the one or more computing devices to perform a method. The method includes receiving a change to a virtual world, the virtual world having been generated from an existing data structure containing original non-geometric data. The method also includes converting the change to the virtual world to generate non-geometric data. The method further includes saving the non-geometric data in the existing data structure.

A further embodiment of the present invention is directed to a method for generating a virtual world. The method includes accessing a first existing data structure containing non-geometric data that was originally generated for a purpose other than creating a virtual world representation. The method also includes accessing a second existing data structure comprising geometric data. The method further includes querying the first and second existing data structures to identify parameters for use in generating the virtual world. The method still further includes designing geometric objects based on the parameters identified from the first and second existing data structures and generating the virtual world using the geometric objects.

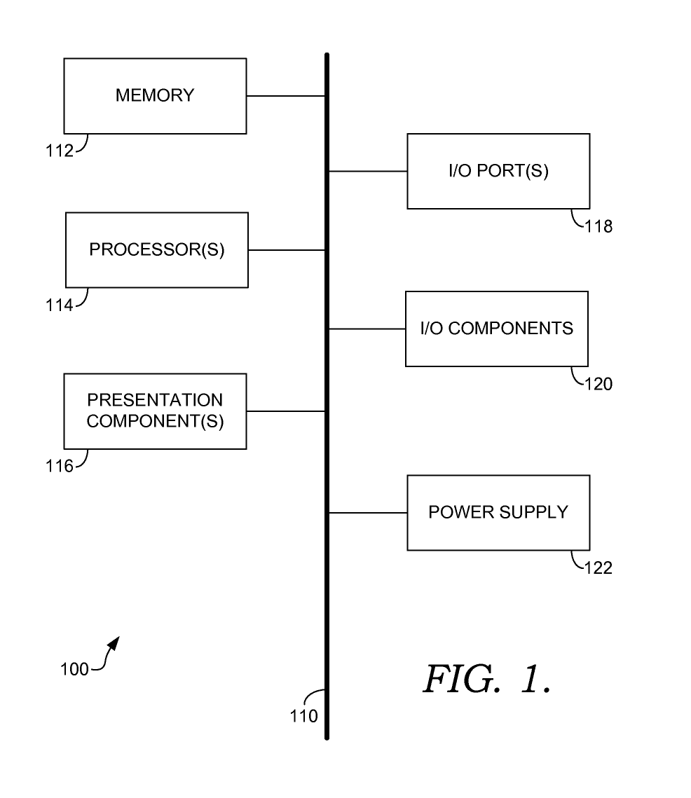

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output (I/O) ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

As discussed previously, embodiments of the present invention are directed to generating a virtual world representation from an existing data structure. The data structure may generally include any pre-existing content. In embodiments, the content may be non-geometric data that was not originally intended to be used to create a virtual world. For example, the existing data structure may be FACEBOOK data, TWITTER data, the USPTO patent database, search engine search results, a user's email inbox, or contents from a word processing document. These are only examples and many other types of pre-existing content may be employed to generate virtual worlds. The existing data may be simple files or may include larger data structures, such as images, videos, music, etc. Generally, anything that's included in the existing data structure may be used to generate aspects of the virtual world.

As can be appreciated, this type of data was not originally meant to be a virtual world and was generated for purposes other than generating virtual worlds. However, creating virtual worlds from such content may be useful to users in a number of different ways. For instance, creating virtual worlds from such data may be useful for understanding data that may otherwise seem abstract to users. In particular, using spatial cognition as a jog to memory is something that works very well for the human brain. Visualizing data in a spatial context is something that's typically easier for the human brain to do than compared to more abstract approaches. As such, taking something that users may find inherently difficult to understand or remember and turning it into a visual representation using a virtual world is something that may make it easier for them to understand and navigate.

By way of specific example to illustrate how embodiments of the present invention may be employed to facilitate users in understanding data, one area of data that has recently been difficult for users to understand is the privacy settings for their FACEBOOK accounts. Generally, it may be difficult for a non-technical person to understand the impact of their privacy settings. Embodiments of the present invention could be incredibly useful for people to test their privacy settings and as a result, better understand the impact of different settings. For instance, a virtual world may be created based on a user's FACEBOOK profile and privacy settings in which different rooms represent different areas of their FACEBOOK profile containing information from those various areas. Each of the doors to the rooms may be locked or unlocked to either allow or prevent access to the rooms (and the information each room contains) based on different privacy settings. A user may then navigate the virtual world to more intuitively understand how the privacy settings affect access to the data.

As another use case example, a virtual world may be created using embodiments of the present invention to serve as a sort of memory castle for a user's FACEBOOK profile. A memory castle (or memory palace or method of loci) is a mnemonic device that people have historically employed to remember large amounts of data. The memory castle is an imaginary world in a person's mind with a number of places that act as memory store of various items a person wishes to remember. The person may then “walk” through this visualization in his/her mind to recall items. In accordance with embodiments of the present invention, a virtual world may be created by taking the social graph of a user's friends in FACEBOOK and turning it into a virtual representation of a memory castle having rooms for each of the user's friends. When the virtual world is navigated and the user enters a friend's room in the memory castle, the user may then access the virtual world representation of the friend's FACEBOOK data. For instance, a user may enter a grand foyer of a castle that represents the user's personal room generated from the user's FACEBOOK profile information. Reaching out from the grand foyer may be a number of rooms corresponding with friends from the user's social graph in FACEBOOK, with each room being built around each friend's FACEBOOK profile. Additionally, reaching out from the friends' rooms may be rooms corresponding with their friends.

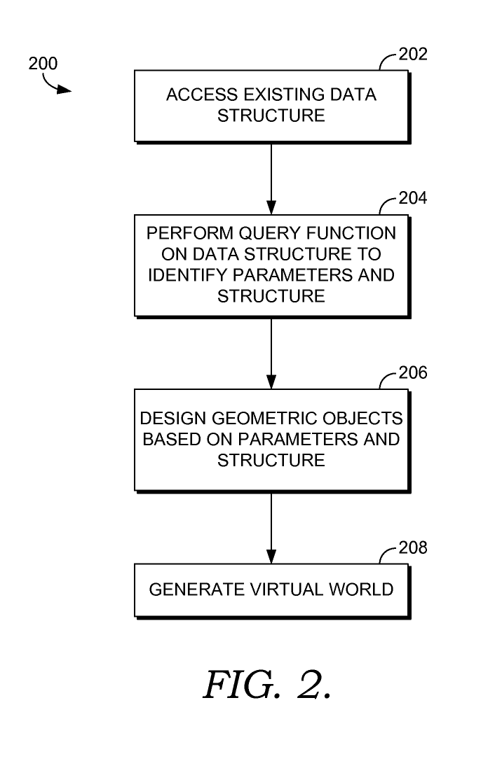

Turning now to FIG. 2, a flow diagram is provided that illustrates a method 200 for generating a virtual world using a pre-existing data structure containing non-geometric data in accordance with an embodiment of the present invention. Initially, as shown at block 202, an existing data structure is accessed. As indicated previously, the data structure may contain pre-existing non-geometric content that was not originally intended for use in generating virtual worlds but instead was generated for other purposes.

A query function is performed on the data at block 204 to analyze the data and identify parameters and the dependency structure of the data for use in generating geometric objects for the virtual world. The criteria used by the query function could identify information such as the contents of particular nodes in the data and graph and tree structures in the data. This may include analyzing any portion of the data structure including tags and metadata associated with data elements.

The output of the query function yields a set of parameters and dependency structure that may be used as inputs to a function that designs geometric objects based on that output. Accordingly, as shown at block 206, the parameters and dependency structure identified by querying the existing data structure are used by a geometric object generation function to build geometric objects for the virtual world. The output from the geometric object generation function is employed at block 208 to generate the virtual world. Using the FACEBOOK example to illustrate, users' profiles and social graphs in FACEBOOK may used to generate a virtual world. The particular parameters of a given FACEBOOK profile may be used to influence the design of a particular room, while the layout of the virtual world including the connectivity from room to room may be determined by the graph structure of the social graph in the FACEBOOK data.

The query function and geometric object generation function may be established in a number of different manners within the scope of embodiments of the present invention. By way of example only and not limitation, the geometric object generation function may include transformation algorithms that map particular data elements into geometric objects. Based on this, the query function may include a filter design to identify certain data elements used by the geometric object generation function while ignoring other data. The selectivity of the filter design may be expressed through logic queries to search for particular data elements in the data structure, using for instance, string-matching or other known functions.

In some embodiments, the functions may be developed using a prototype and inference approaches. In particular, a fictional or sample data structure and a prototype virtual world representation of that data structure may be provided. Based on these inputs, artificial intelligence inference, machine-learning, Bayesian, and/or other techniques may be employed to automatically derive the rules that would have converted data from that fictional or sample data structure into the prototype virtual world representation. Those rules may then be used (for instance, in the method 200 described above with reference to FIG. 2) by the querying and geometric object generation functions to automatically generate virtual worlds from existing data structures.

The process of converting an existing data structure to a virtual world may be done automatically (e.g., without any user input) and in real-time in embodiments of the present invention. Additionally, in some embodiments, the underlying data structure may include dynamic real-time data, such as TWITTER feeds or FACEBOOK news feeds. The virtual world may be continuously updated by such dynamic real-time data.

Portions of the virtual world may also be generated on-the-fly as a user navigates through the virtual world. This may require anticipatory algorithms to anticipate the needs for pre-caching, pre-interpreting, and/or pre-computing data based on a user's navigation in the portions of the virtual world already created to generate the additional portions of the virtual world. The use of anticipatory algorithms may be particularly useful, for instance, in embodiments employing a network or cloud-based service, in which there may be quality of service or latency issues. The anticipatory algorithms may be driven by the structures in the original data rather than any virtual world design. In other words, because the new portions of the virtual world have yet to be created at that time, the system may not rely on just the virtual world design but rather the structure of the underlying non-geometric data to anticipate the particular pre-caching, pre-interpreting, and/or pre-computing needs.

The translation of data from an existing data structure to a virtual world may be a “literal” or “non-literal” translation. By way of illustration, a literal translation may take input data that indicates that two friends are jogging in a particular park and generate a virtual world with avatars of those friends running in a virtual world version of the park. As an example of a non-literal translation, the system may take information regarding a user's friends in FACEBOOK and generate butterflies of the friends with the size of each butterfly corresponding with how long each has been a friend of the user. As another example of how parameters may be used indirectly or in a non-literal way, when generating a memory castle based on a user's social graph in which each room corresponds with each friend, the height of each room may be based on each friend's height.

In some embodiments of the present invention, the generation of virtual worlds from existing data structures may be done in a way that provides for different views. For instance, virtual worlds may be built on the fly from existing data based on context, such as the use scenario, the identity of the user who will be viewing and navigating the virtual world, that user's preferences, or that user's access rights to the underlying data. As such, the view of the virtual world created based on the same existing data structure may vary from user to user or other contexts.

Additionally, a single user may have different virtual worlds or different views of a virtual world created from the same existing data structure. This may be useful, for instance, in the example above regarding using virtual worlds to facilitate users understanding their FACEBOOK privacy settings. For example, a user may specify various access scenarios to the user's FACEBOOK profile (e.g., different users attempting to access the user's FACEBOOK data) and a number of virtual worlds or views of a virtual world may be generated based on those access scenarios. The user may then navigate each view of the virtual world to determine how the privacy settings affect access to the FACEBOOK data for each of the access scenarios. Based on this, the user may better understand the privacy settings and adjust the privacy settings to appropriately reflect the user's access preferences. The user may iteratively tweak the privacy settings and see how those settings affect the views of the virtual world to better understand how changes to the privacy settings affect access to the FACEBOOK data.

A user may also be able to access different views of information when navigating a particular virtual world that has been created based on an existing data structure. For instance, when a user views a structure from a distance, the user may see certain information. However, when viewing the same structure from close-up the user may view different information.

In some embodiments, a virtual world may be generated using not just the data as it exists at a particular moment but also different versions of the same data set over a period of time. In other worlds, the virtual world may reflect past states of the data in addition to the present state. This may be a way, for instance, for people to track events over time so they can go back and view how the data has changed over time. Accordingly, in some embodiments, the history of a data structure may be reflected in the design of the virtual world representation.

By way of illustration, suppose that the virtual world is a virtual office that accumulates design elements that reflect the history of work on a particular project. Additionally, the design of the virtual world may reflect the relationship between stages. This would allow the user to better recall how things happened, such as whether events happened together or separately, whether one event led to another, etc. As another example, the virtual world may be a long hallway with the same room repeated again and again to represent the data at different times. As the user walks down the hallway to each room in the virtual world, the user is moving backwards in time and seeing the data as it existed at different stages.

In some embodiments, changes may be made to the virtual world by a user while the user is viewing and navigating the virtual world. This is another way in particular in which the virtual world may provide a richer way to view data than can be done when viewing the data without the use of a virtual world. For instance, the changes made in the virtual world may maintain the conditions with which the changes were created. By way of example to illustrate, suppose that a virtual world is created from a user's FACEBOOK data with a physical wall that represents the “wall” from the user's FACEBOOK profile on which other users may post messages and other comments. Different users may view and write on the wall in the virtual world from different distances or perspectives. Those comments may then only be viewed by other users when viewing the wall from the same distance or perspective. This distance or perspective may have different meanings. For instance, the wall may have different views based on different user groups such that users may view the wall from different perspectives based on the user group(s) to which the different users belong. The wall may also have different views based on any number of other factors, such as the topics of comments or based on when the comments were written.

The virtual world and underlying data structure from which it was created may also have a bidirectional relationship. In particular, while the virtual world is created from the underlying data structure, changes made in the virtual world may be translated back and result in changes made to the underlying data structure. For instance, kicking a friend out of a user's memory castle in a virtual world may be converted to “defriending” that person in the user's FACEBOOK profile.

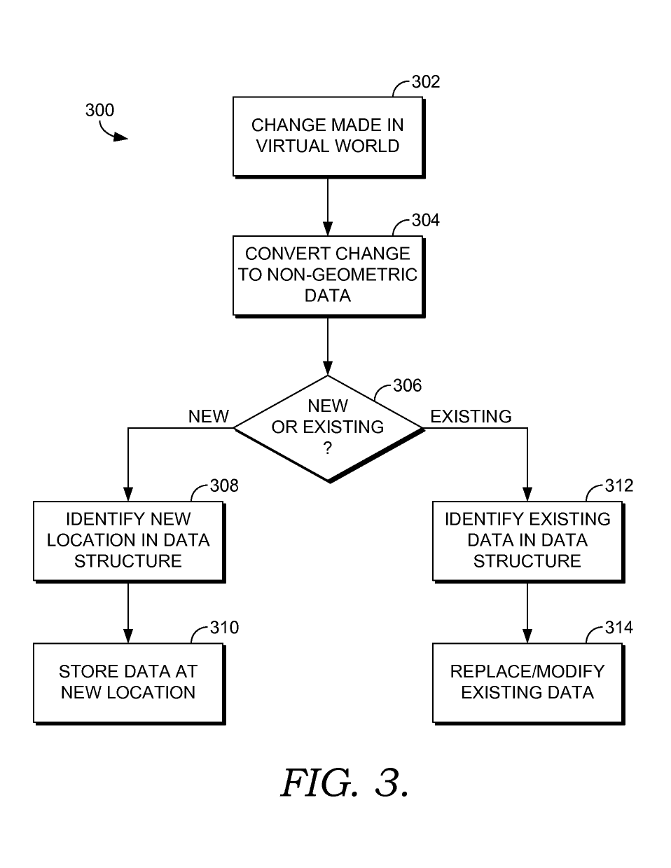

Referring now to FIG. 3, a flow diagram is provided that illustrates a method 300 for making changes to an underlying data structure based on changes made to a virtual world in accordance with an embodiment of the present invention. As shown at block 302, a change is made in a virtual world that was originally generated from an underlying data structure containing non-geometric data. For instance, the virtual world may have been generated using the method 200 discussed above with reference to FIG. 2.

The change made in the virtual world is converted to non-geometric data, as shown at block 304. The back channel to convert virtual world changes to non-geometric data may be provided in a number of different ways in various embodiments of the present invention. In some embodiments, the back channel to convert changes in the virtual world to non-geometric data may be based on transformations that aren't necessarily related to the forward transformations used to generate the virtual world. As such, one set of transformations may be used to create the virtual world from the original source data and another set of transformations may be used to create non-geometric data from changes to the virtual world. Essentially, the two algorithms (the forward transformations and reverse transformations) may be independent of one another. In some embodiments, some of the forward transformations that were used to convert original source data to geometric objects for generating the virtual world may allow for reverse transformations for converting virtual world changes to non-geometric data. In other words, some transformations may be inherently bidirectional. In such instances, the transformations used to convert original source data to virtual world objects may be used in the reverse to convert changes to the virtual world to non-geometric data. Any and all such variations are contemplated to be within the scope of embodiments of the present invention.

In some instances, the change in the virtual world may result in new data being added to the existing data structure, while in other instances, the change may result in changes to data in the existing data structure. Accordingly, a determination is made at block 306 regarding whether the change to the virtual world creates new data or changes to existing data. If the change results in new data, a new location in the data structure to store the data is identified at block 308. The new data corresponding with the change in the virtual world is then stored at the new location, as shown at block 310. Alternatively, if the change to the virtual world affects a change to existing data in the data structure, the existing data in the data structure is identified at block 312. The existing data is then replaced or modified, as shown at block 314.

In accordance with some embodiments, the entire virtual world may be created based on an existing data structure of non-geometric data. This may include generating all aspects of the virtual world including all geometric objects within the virtual world based only on the non-geometric data. This may also include creating avatars included in the virtual world from the non-geometric data of the existing data structure. Embodiments also include mapping concepts that may not be visual into some visual representation. Feelings, wishes, statuses may all be represented in some way (e.g., icon, avatar status, etc.). For instance, “glowing” could be used as a signal for a wish for some relationship. Additionally, different people may have different interpretations or preferences regarding the semantics of different displays. Each user may be given the ability to choose his/her representation or invent a new one. In some embodiments, a global crowd representation (e.g., the most common representation chosen by users similar to use) may be the default representation shown to a user.

While in some embodiments the entire structure of the virtual world is generated using an existing data structure of non-geometric data, further embodiments may also employ geometric data when generating the virtual world. By way of example to illustrate, the system may be leveraged to provide instructions to a contractor performing work in a user's house. The inputs to the system may include: (1) geometric data such as a scan of the user's house using a depth camera or a three-dimension model of the user's house generated from a PHOTOSYNTH application; and (2) non-geometric data of notes to the contractor of what work needs to be performed. Based on these inputs, a virtual world may be created that includes a three-dimensional representation of the user's house and provides an indication of what work needs to be done and where it needs to be performed in the house. Parameters from the instructions (i.e., the non-geometric data) and the three-dimensional model of the user's house (i.e., the geometric data) may be combined when designing geometric objects for the virtual world, for instance, to virtually represent particular objects in the virtual representation of the user's house as requiring repair. This would provide a number of advantages, including, for instance, allowing the contractor to provide an estimate without even visiting the house and/or would help the contractor in locating what needs to be done when arriving at the house.

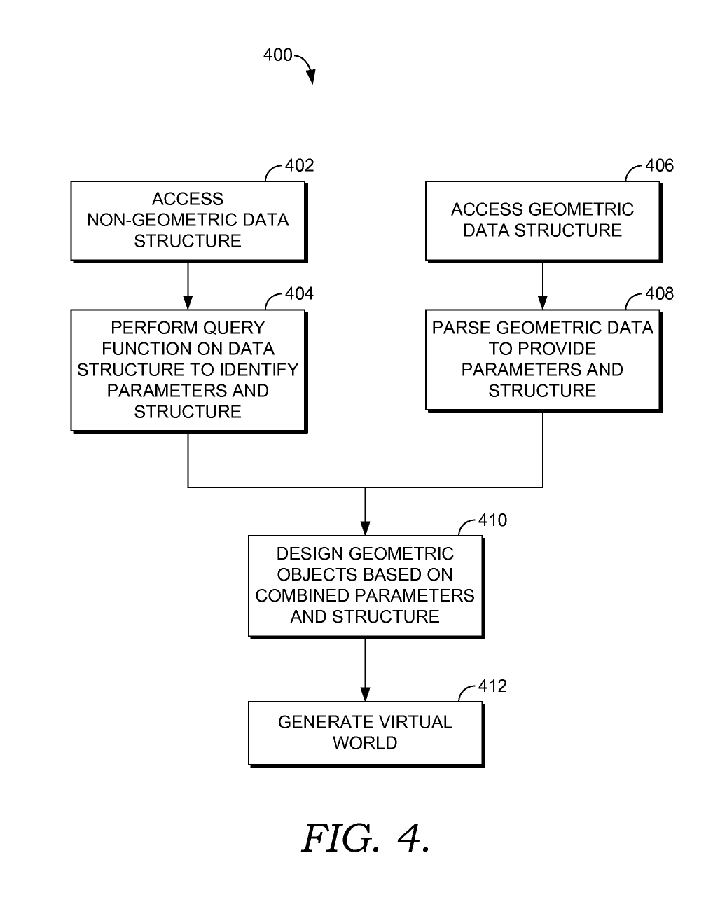

Turning to FIG. 4, a flow diagram is provided that illustrates a method 400 for employing both non-geometric data and geometric data to generate a virtual world in accordance with an embodiment of the present invention. As shown at block 402, a data structure containing non-geometric data is accessed. As indicated previously, this data structure may include data that was not originally intended to be used in generating virtual worlds. A query function is performed at block 404 to identify parameters and structure in the data to use for virtual world generation. This may be performed similar to block 204 of the method 200 discussed above with reference to FIG. 2.

A data structure containing geometric data is also accessed, as shown at block 406. In some embodiments, this may include data regarding a virtual world that was previously generated. In other embodiments, this may include geometric data regarding the real world that may include, for instance, a three-dimensional model using depth sensors, a three-dimensional model using the PHOTOSYNTH application, or data from other approaches to capturing real world geometric data. The geometric data is parsed at block 408 to identify parameters and structure from the geometric data to use in generating the virtual world.

In some embodiments, the parameters identified from the data structures may be independent of one another. However, in other embodiments, the parameters identified for use in generating the virtual world may have some dependency between the two data structures. For instance, the parameters identified from the data structure containing non-geometric data may be identified based on parameters identified from the data structure containing geometric data, and vice versa.

Using the combined parameters and structure identified from the non-geometric data structure and the geometric data structure, a geometric object generating function is performed that builds geometric objects, as shown at block 410. The output from the geometric object generation function is then employed at block 412 to generate the virtual world.

As can be understood, embodiments of the present invention provide for the automatic generation of virtual worlds from existing data structures containing non-geometric data that may not have been originally intended for virtual worlds. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions, that when used by one or more computing devices, cause the one or more computing devices to perform a method, the method comprising:
accessing an existing data structure containing non-geometric data that was originally generated for a purpose other than creating a virtual world representation;
querying the existing data structure to identify parameters for use in generating a virtual world;
designing geometric objects based on the parameters identified from the existing data structure; and
generating the virtual world using the geometric objects.

2. The one or more computer-storage media of claim 1, wherein querying the existing data structure includes querying the existing data structure to identify dependency structure of data within the existing data structure, and wherein the geometric objects are designed based on the parameters and the dependency structure identified from the existing data structure.

3. The one or more computer storage media of claim 1, wherein the existing data structure includes real-time data that is used to generate the virtual world.

4. The one or more computer storage media of claim 1, wherein the entire virtual world is generated from the existing data structure.

5. The one or more computer storage media of claim 1, wherein the method includes:
receiving user navigations in the virtual world;
determining that additional portions of the virtual world need to be created based on the user navigations;
querying the existing data structure to identify additional parameters;
employing the additional parameters to design additional geometric objects; and
generating the additional portions of the virtual world using the additional geometric objects.

6. The one or more computer storage media of claim 1, wherein accessing the existing data structure comprises accessing different versions of the existing data structure from different periods of time, and wherein querying the existing data structure comprises querying the different versions of the existing data structure to identify the parameters for use in generating the virtual world such that the virtual world reflects the different versions of the existing data structure.

7. The one or more computer-storage media of claim 1, wherein the method further comprises:
receiving a change in the virtual world;
converting the change to the virtual world to generate new non-geometric data; and
saving the new non-geometric data in the existing data structure.

8. The one or more computer storage media of claim 1, wherein the method further comprises:
accessing a second existing data structure containing geometric data; and
querying the second existing data structures to identify additional parameters for use in generating the virtual world;
wherein the geometric objects are designed based on the parameters identified from the existing data structure containing non-geometric data and the additional parameters identified from the second existing data structure containing geometric data.

9. The one or more computer storage media of claim 8, wherein the geometric data comprises geometric data from a previously generated virtual world.

10. The one or more computer storage media of claim 8, wherein the geometric data comprises geometric data generated from the real world.

11. One or more computer storage media storing computer-useable instructions, that when used by one or more computing devices, cause the one or more computing devices to perform a method, the method comprising:
receiving a change to a virtual world, the virtual world having been generated from an existing data structure containing original non-geometric data;
converting the change to the virtual world to generate non-geometric data; and
saving the non-geometric data in the existing data structure.

12. The one or more computer storage media of claim 11, wherein converting the change to the virtual world to non-geometric data comprises using a reverse transformation that corresponds with a forward transformation that was used to generate the virtual world from the original non-geometric data.

13. The one or more computer storage media of claim 11, wherein converting the change to the virtual world to non-geometric data comprises using a reverse transformation that is unrelated to a forward transformation that was used to generate the virtual world from the original non-geometric data.

14. The one or more computer storage media of claim 11, wherein saving the non-geometric data in the existing data structure comprises saving the non-geometric data as new non-geometric data in the existing data structure.

15. The one or more computer storage media of claim 11, wherein saving the non-geometric data in the existing data structure comprises replacing or modifying a portion of the original non-geometric data in the existing data structure.

16. A method for generating a virtual world comprising:
accessing a first existing data structure containing non-geometric data that was originally generated for a purpose other than creating a virtual world representation;
accessing a second existing data structure comprising geometric data;
querying the first and second existing data structures to identify parameters for use in generating the virtual world;
designing geometric objects based on the parameters identified from the first and second existing data structures; and
generating the virtual world using the geometric objects.

17. The method of claim 16, wherein the geometric data comprises geometric data from a previously generated virtual world.

18. The method of claim 16, wherein the geometric data comprises geometric data generated from the real world.

19. The method of claim 16, wherein querying the first and second existing data structures includes querying the first and second existing data structures to identify dependency structure of data within each of the first and second existing data structures, and wherein the geometric objects are designed based on the parameters and the dependency structure identified from the first and second existing data structures.

20. The method of claim 16, wherein the method further comprises:
receiving a change in the virtual world;
converting the change to the virtual world to generate new non-geometric data; and
saving the new non-geometric data in the first existing data structure.
